(19) United States
(12) Patent Application Publication
(10) Pub. No.: US 2006/0171288 A1
(43) Pub. Date: Aug. 3, 2006

(54) Optical disk assay device, system and method

(75) Inventor: Frans A. Kuypers, El Cerritos, CA (US)

Correspondence Address: STEVENS LAW GROUP, P.O. BOX 1667, SAN JOSE, CA, 95109, US

(73) Assignee: Children's Hospital Oakland Research Institute

(21) Appl. No.: 11/325,194

(22) Filed: Jan. 3, 2006

Related U.S. Application Data
(60) Provisional application No. 60/641,173, filed on Jan. 4, 2005.

(51) Int. Cl. G11B 7/24

(52) U.S. Cl. 369/275.1

(57) ABSTRACT

An optically readable device is provided for use in an assay process, where the device includes a surface readable by an optical reading device and at least one binder located on the surface for exposure to a medium and configured to bind to a target entity that may be present in the medium. An optical reading can then read the target entity using appropriate software for reading, counting or otherwise analyzing the entities bound to the disk. The device may further be exposed to another medium that includes obstructions such as assay beads that are configured to bind to the bound target entities on the disk, so that their presence may be detected by the optical reading device.

### RELATED APPLICATIONS

This application claims priority based on U.S. Provisional Application No. 60/641,173, filed on Jan. 4, 2005.

### BACKGROUND

The invention relates generally to assay devices and methods, and more particularly to an optical disk assay device, system and methods of use.

In the fields of biological and biochemical testing and analysis, the use of ELISAs (Enzyme-Linked Immunosorbent Assays), are well known. An ELISA is a sensitive immunoassay that uses an enzyme linked to an antibody or antigen and used as a marker for the detection of a specific protein. This link is synonymous with a key and a lock, where, metaphorically speaking, the antibody is a key, and the specific protein holds a lock into which the key fits. Thus, there must be certainty that detection occurs where the key (the antibody) fits. Common test kits are available for many different applications. However, these kits generally only perform a test for a single analyte, and require. specialized test equipment to detect and/or measure the specific protein in question.

Additionally, flow cytometry may be used to measure concentrations of biological solutions. Flow cytometry is the analysis of biological material by detection of the light-absorbing or fluorescing properties of cells or sub-cellular fractions (i.e., chromosomes) passing in a narrow stream through a laser beam. An absorbance or fluorescence profile of the sample is produced. However, flow cytometers are expensive, specialized test instruments, and are therefore not readily available.

It would therefore be desirable to have an inexpensive and easy to use device to detect and measure biological and biochemical material. As will be seen, the invention accomplishes this and overcomes the deficiencies in the prior art in a novel and elegant manner.

### THE FIGURES

FIGS. 1A-D are illustrations of an optical disk according to the invention;

FIGS. 2A-C are illustrations of an optical disk being exposed to binding entities according to the invention;

FIGS. 3A-C are illustrations of an optical disk being exposed to binding entities according to the invention;

FIGS. 4A-B are illustrations of an optical disk being exposed to binding entities according to the invention and a related analysis graph;

FIGS. 5A-B are illustrations of an optical disk having multiple tracks with separate binders being exposed to binding entities according to the invention and a related analysis graph;

FIG. 6 is an illustration of a method according to the invention;

FIGS. 7A-D are illustrations of a method and related optical hardware according to the invention; and

FIG. 8 is an illustration of a system configured according to the invention.

### DETAILED DESCRIPTION

The invention is directed to an optically readable device for use in an assay process, where a surface readable by an optical reading device has at least one binder located on the surface for exposure to a medium and the binder is configured to bind to a target entity that may be present in the medium. The optically readable device may be a compact disc (CD), a digital video disc (DVD), a device readable by a raster scanner, or any other optical device that operates to read a surface using optical means. An optical reading device, typically run by a CPU having software for reading an optically readable device, can then run a program to detect empirical data from the presence of one or more target entities bound to the binder.

In one embodiment, the invention is directed to an optically readable device for use in an assay process, that includes a surface readable by an optical reading device; and at least one binder located on the surface for exposure to a medium and configured to bind to a target entity that may be present in the medium. The binder is embedded in the plastic surface, or may be an active amino group embedded in the plastic surface. The invention further includes an identifier configured to bind to a target entity to aid in detecting the presence of any target entities on the surface. The disk surface may include a top layer configured to hold at least one binder, and an inner layer configured to retain optically readable inner surface entities, the device further comprising software code that, when processed by a data processor, enables the data processor to detect the presence of any target entities on the top layer. The surface may include a top layer configured to hold at least one binder and an inner layer configured to retain optically readable inner surface entities, the device further comprising software code that, when processed by a data processor, enables the data processor to detect the presence of any identifiers on the top layer. The invention may be embodied in an optically readable disk, where optically readable code is located on a section of the optical disk, where the code, when read and processed by a data processor, enables the data processor to detect the presence of any target entities on the surface. The surface may include a top layer configured to hold at least one binding entity, and an inner layer configured to retain optically readable surface entities located on the inner layer. In another embodiment, the surface includes a top layer configured to hold at least one binding entity, and an inner layer configured to retain optically readable inner surface entities, the device further comprising software code that, when processed by a data processor, enables the data processor to detect the presence of any target entities on the top layer. The disk may includede optically readable code located on a section of the inner layer in the form of optically readable entities, where the code, when read by an optical reading device and processed by a data processor, enables the data processor to detect the presence of any target entities on the top layer. Again, the surface may include a top layer configured to hold at least one binding group and an inner layer configured to retain optically readable target entities, the optical disk further comprising optically readable code located on a section of the inner layer in the form of optically readable entities, where the code, when read by an optical reading device and processed by a data processor, enables the data processor to detect the presence of any target entities bound to a binding group on the top layer. The top layer may further include active amino groups embedded therein configured to bind to target entities located within the medium. The optically readable code includes code configured to enable an optical reading device to detect errors at positions on the top layer where target entities in the medium bind to the binding entity.

The optically readable disk may include the optically readable code, which may include code configured to enable an optical reading device to detect errors at positions on the top layer where target entities in the medium bind to the binding entity, wherein a processor, when executing the code, is configurable to determine whether a number of read errors is related to the number of target entities located in the medium.

In operation, the system may perform the process of treating an optical disk with a binding entity to a material of interest; exposing the disk to a solution containing the material of interest, such that the material of interest binds to the binding entity; reading the disk in an optical disk reader; and counting the number of read errors caused by the material of interest on the optical disk; wherein the number of read errors is proportional to an amount of the material of interest. Prior to reading the disk, the disk may be exposed to a secondary binding entity to the material of interest, wherein the secondary binding entity carries a substance which will cause a read error. Also, different disk sections may be treated with different binding entities. The method may include measuring the size of a cell by treating an optical disk with an antibody to the cells; exposing the disk to a solution containing the cells, such that the cells bind to the antibody; reading the optical disk in an optical disk reader; and analyzing read errors from the optical disk reader caused by the cells, such that error analysis determines a pattern of the errors and a corresponding size of the cells. The target entity may be a cell or other entity in this example, and the optical disk may be treated with a plurality of antibodies configured to bind different target entities.

Optical reading hardware and related controllers and software are configured to detect the presence of antibodies on the surface using ordinary optical reading devices, such as a CD or DVD reader used in most computers, laptops or other devices. Raster scanners also exist that read optical surfaces, and can be configured to operate according to the novel methods of the invention. Well known error checking software exists that is configured to detect errors on the optical reading surface of a CD or DVD, and, according to the invention, can be adapted to check for the presence of target entities attached to a surface by the antibodies. Those skilled in the art will understand that there is a wealth of optical reading hardware and software and related controller components that exists in the art that can be easily adapted without any undue experimentation. Generally, an optical surface of a CD or DVD player is made up of pits, both long and short, and lands, that define logic 0's and 1's. Error checking software is configured to detect defects on the optical surface that are large enough to distort the reading of the data from the disc. According to the invention, such components and related software is used to detect the presence of target entities on the surface of an optical disc, to quantify the target entities and to make computations related to the quantity, quality and other characteristics of the target entities in the medium being tested and measured. Thus, the target entities, once bound to the disk, can cause errors that the error checking software can detect as errors.

If the target entity is not large enough to be detected as an error, a secondary antibody attached to a more obstructive object, such as beads used on cytometry, so that the error checking software can detect the presence of the target entity on the optical surface. Such antibodies and related beads are well known in the art of cytometry, and will be well understood by those skilled in the art to exist in many varieties, particularly in sizes that can be detected by error testing software according to the invention.

Again, in some applications, the target entity may be too small to be detected by the optical reading device. In this case, a second binder may be connected to an obstructive object that can be detected by the optical reading device. Such an object would be large enough to be detected, such as that known in the art as a bead discussed further below. Thus, when the target entity that is bound to the surface is then exposed to the other binder connected to the bead, an optical reading device can then read the bead as evidence of the existence of the target entity in the medium.

The target may be organic or inorganic chemicals, biological, biomedical, complex or simple. The invention is adaptable to any system where a target entity exists in a medium, and where an antibody can be affixed or otherwise associated with a surface in order to attract and bind to the target entity. The medium may be a fluid, gas, or vapor, and may be a substance sputtered, sprayed or otherwise exposed to the binder. For example, one or more binders can be connected to a surface, and then the surface with the binders can be exposed to a blood sample, where certain blood cells are attracted to the binders on the surface. Once bound to the surface, they may be detectable to error checking software commonly used to check for errors in optical disk surfaces. If they are too small to show up as errors, a second binder attached to a larger entity, such as a bead as discussed below, that can be detected by error software can be exposed to the disk, attaching them to the bound blood cells. Thus, the error checking software can detect the larger entity, or bead, and count the bound cell on the optical surface.

The optical surface can then be scanned or simply read by a compact disc reader that is configured with appropriate error checking software. Such software is well know in the art, and would be easily adapted to an application embodying the invention without any undue experimentation. Typically, error checking software checks the number of errors by percentage or number, records the errors during a checking process, but stops at a point where a certain number of errors are found, rendering the optical surface useless for use in storing data. According to the invention, however, such software can be easily modified to continue checking until all tracks of the optical disc are examined, giving an accurate count of the entities relevant for the test.

Applications may include detection of bacteria or other biological entities in water systems, chlorine content in a pool, different organic and inorganic entities in lakes or water systems, and many other applications.

In one embodiment, the binder is embedded in the plastic surface. In another embodiment, the binder is an active amino group embedded in the plastic surface. The invention may further include an identifier configured to bind to a target entity to aid in detecting the presence of any target entities on the surface. An example is a bead or other obstructive entity that would be detectible by error software run using an optical reading apparatus, which is discussed in more detail below. The surface may include a top layer configured to hold at least one binder, and an inner layer configured to retain optically readable inner surface entities. The device may further include software code that, when processed by a data processor, enables the data processor to detect the presence of any target entities on the top layer. If the binder is embodied on an optically readable disk, the software may be embedded within the optical medium.

The readable surface may be simple, in that it can simply be readable by an optical reading device when there are target entities. For example, the optical reading device may read the presence of target entities present, whether they have any secondary entity bound to it, such as a bead for example. Thus, commonly used reading software can be configured to simply detect and count or otherwise record the presence of target entities in a medium. Such software can be well known error checking software, or can also include any of a number of reading software applications that can be easily coded to detect and record the presence of target entities in a medium. Thus, a disk could be used that does not have optically readable tracks. It could have a background that is simply the land of the disk, whether it is made of silicon or any other material. Thus, a simple disk surface where there is only a land, no pits, and that picks up the binding entity with binders, such as antibodies attached to the disk surface. Then, beads or other obstructions having binders can be exposed to the surface.

The surface of the medium may include a top layer configured to hold at least one binder and an inner layer configured to retain optically readable inner surface entities, the device may thus include software code that, when processed by a data processor, enables the data processor to detect the presence of any identifiers or target entities on the top layer.

In one embodiment, the surface includes a top layer configured to hold at least one binding entity, and an inner layer configured to retain optically readable surface entities located on the inner layer. Alternatively, the surface may include a top layer configured to hold at least one binding entity, and an inner layer configured to retain optically readable inner surface entities, where the device has software code that, when processed by a data processor, enables the data processor to detect the presence of any target entities on the top layer. Those skilled in the art will understand that simple modifications to an optical reading medium can be made to enhance or simplify the testing and measuring process according to the invention. For example, an optical reader may be able to read a surface that is prepared with antibodies and exposed to a medium, whether secondary obstructive entities are used or not used, whether there is an optical surface that is digitally readable by an optical reader or not. The optical reader could simply read the errors occurring on the surface caused alone by the target entities or secondary entities that are used to identify the target entities. The invention, however, is not limited to any particular optical surface configuration, but extends to any optically readable surface that can be used in conjunction with error checking software to detect the presence of the target entities in the medium being tested.

In one embodiment, the invention is directed to a system, device and method for determining the concentration of biochemical or biological entities using an optically readable surface, such as an optical disk. More particularly, an optical disk may be covered with binding entity, such as an antibody to a specific target to be measured. The surface may be treated with a binding entity or agent in a number of ways, including sputtering, spraying, printed or imprinted onto the optical surface. Those skilled in the art will understand that there is a wealth of different types of methods

This may be accomplished, for example, by using well known standard inkjet printer technology to print directly onto the disk using a solution of the binding entity, or other similar method. Those skilled in the art will understand that there are many ways to apply, embed or otherwise bind the binding entity to the optical surface, thus making the optical surface attractive to the target entities that are bound to or otherwise receptive to the binding entities.

In operational use, the disk is exposed to a medium, such as a liquid, vapor or gas, containing the target to be measured, such as a protein. Once introduced into the medium, the target binds to its binding entities, such as antibodies on the disk surface. The disk may then be rinsed or washed to remove any other superfluous material that is not relevant to the testing or measuring. If the bound entities are not large enough to be detected by the error checking software and associated optical reading means, then the disk may subsequently be exposed to a secondary compound such as another antibody, which may be the same or a different antibody as the antibody on the surface, or may be another antibody attached to a bead or other obstructive entity that is readable by the optical reader. The secondary binder will ultimately bind to the target and interfere with normal detection of the digital information on the optical disk.

If the optical surface is an optical disk, such as a CD or DVD, which is then read by an optical reader, there will be a read error at each location of a bound target, since the normal pit that is read by the error checking software that searches for errors on the disk will not be readable. The number of read errors is directly proportional to the number of bound targets, and therefore the concentration of the original solution can be calculated.

Since many commercially available optical readers, such as CD or DVD players, include built-in error detection and correction, a more ideal reader for the invention is a reader that does not perform any such correction, but merely passes the read error information to the control software for counting. Also, the disk may also be covered with different solution on different sections of the disk in order to perform multiple measurements utilizing a single disk. Thus, as described herein, the invention provides an economical and convenient system for biological and biochemical measurement and analysis.

The invention is an improvement over the prior art in that it offers increased sensitivity with respect to measurements such as ELISA, and can also perform multiplex tests i.e. using a single sample to measure multiple analytes. Furthermore, the invention does not require a specialized and expensive optical test instrument, but instead uses a relatively inexpensive optical disk reader, which may come with modern laptop or desktop computers.

According to the invention, the term of binding to “plastic” is intended to be interpreted broadly, for example, the plastic may be that which is used to sandwich laser sensitive material in CD's or DVD's as currently used. It may also include plastics that can be made that have binding groups embedded. For example, predetermined binding groups can be bound chemically (covalently). As another example, embedding active amino groups allows simple chemistry to bind virtually anything to the plate, which in turn may be specific for the analyte to be tested.

Sensitivity and linearity is determined by the sensitivity of the optical disk and the corresponding optical reading device, which may simply measure the number of events. For example, even if a fraction of a 700 mB disk is covered, millions of occurrences of target entities can be detected and measured. Hence concentration limits, on the low end, are only limited by non-specific noise. Therefore, femto molar amounts can be detected. Similarly, the linear range may be large, orders of magnitude, as this only depends on the coverage of the plate, or the number of errors can be made. One possible range may be from mM (moles) to fM, depending on the compounds under scrutiny. This can be very useful if the specific range is not known.

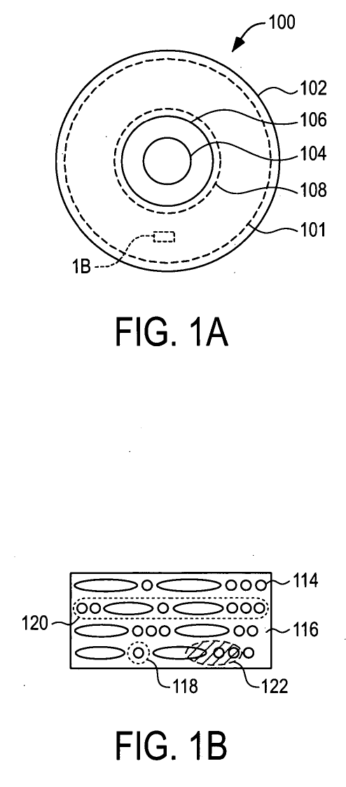

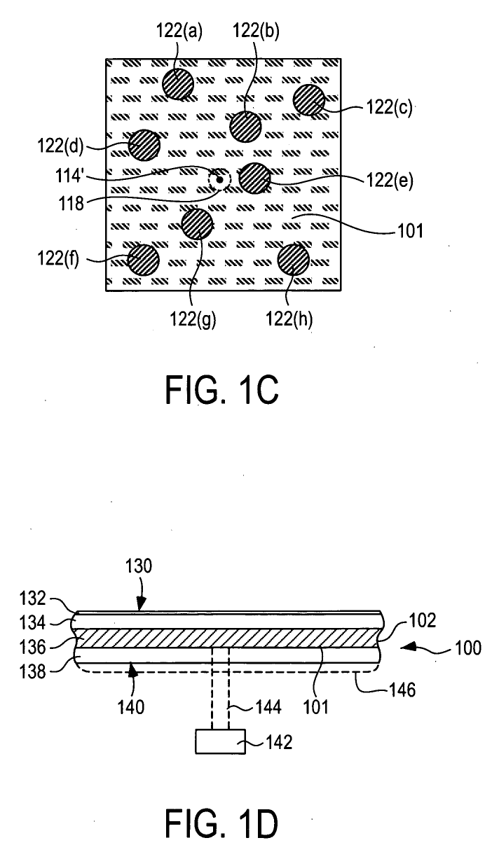

Referring to FIG. 1A, this figure illustrates a typical optical disk for use in an optical disk reader found in any many computers today. The invention is directed to use such a disk with one side, the side read by an optical reader, treated with one or more binders, such as antibodies for example. The disk, known as a compact disk or CD 100, includes a surface 101, an outer diameter 102, and inner diameter 104 and a surface set off ridge 106 protruding from the service for the purpose of preventing the surface 101 from contacting another service or objects or debris. There also exists a usable surface that is located between inner data border 108 and out data border 110, where optical data can be recorded. There also exists unused portions of the disk located between the surface set off ridge 106 and the inner diameter 104 as well as the surface between the out diameter 102 and the outer data border 110. This allows the disk to have a set-off boundary so that data can be recorded on a surface away from areas that may be damaged by handling, mounting the disk onto a disk drive, or other uses of the disk. Also, there is typically an engagement mechanism (not shown) that holds the disk by protruding through the inner diameter 104 and possibly contacting the unused portion of the disk located between the inner data border and the inner diameter.

Referring to FIG. 1B, an expanded illustration of surface area 112 is illustrated. This surface view illustrates a series of pits 114 and lands 116 arranged in tracks 120 that run in a radial manner around the disk. Thus, when the disk is turned on a disk player, these tracks are read by an optical reader that is configured to detect the pits and lands that illustrates zeros and ones in the digital domain. Also illustrated is a light beam radius 118 that illustrates the general size of the light beam that is shown on the surface in order to read the pits and lands from the disk. Defects 122 may occur in several locations on the disks, and cause an error in reading the disk, since they are abnormal, not reflecting the normal pattern of the pits and lands that are actually recorded on the optical disk.

Referring to FIG. 1C, another illustration of an expanded surface view 112 is illustrated, several defects 122A through 122H are illustrated. This is more typical of a disk having errors. In operation, the light beam 118 is shown onto the surface 101 in order to read the pits and lands that are recorded in the optical surface. The defects, 122A through 122H, however, appear as defects, as they do not follow the normal size and pattern of the pits and lands or the characteristics of the reflection of the light beam normally experienced by the beam when shining on the pits and lands. Thus, errors occur on a typical disk surface. Error detection software exists that is capable of detecting such errors by a percentage and measuring these errors in order to determine whether the optical disk is fit for use. A certain finite number of errors are tolerable at a given application, so long as the date recorded in form of the pits and lands and the environment of the existing errors still has integrity.

Referring to FIG. 1D, a side cutaway view of the optical disk of FIG. 1A is illustrated. Specifically, the top surface 130 is an unused surface of the disk in optical terms, where the label of the disk is placed on by adhesive or other means. The disk further includes a first layer 132 that is the actual label that is placed on the surface. Layer 134 is a plastic surface that covers optical media 136 on one side to protect the metal surface of the optical surface. A second plastic surface 138 covers the other side of the optical disk 136, and is the surface in which the data is read through on the readable surface 101. This layer 138 has a surface 140 that is the plastic surface of the optical disk, a contrast to the surface 101, which is the surface of the optical layer that includes the pits and lands and also defects that are read by an optical apparatus 142 that projects an optical beam, typically a laser beam, 144 onto the surface 102 to read the pits, lands, and defects. According to the invention, another layer 146 is placed upon surface 140 by process discussed below, in order to attract target particles that will act as defects or appear as defects on the surface of the disk when read by the laser apparatus 142 shining beam 144. This is discussed in more detail below.

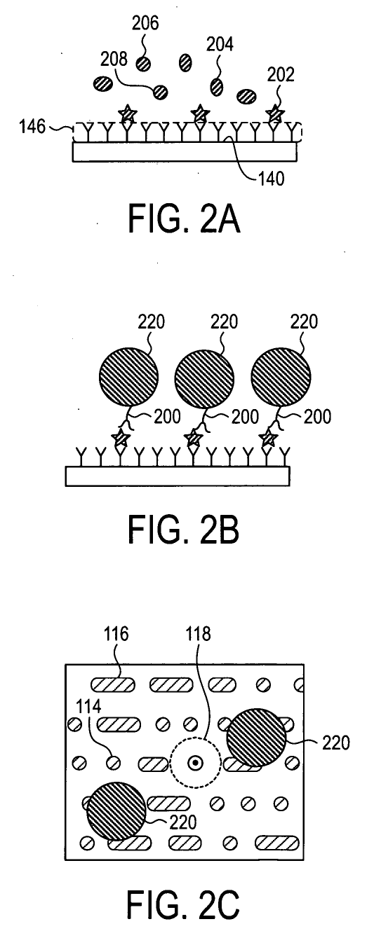

Referring to FIGS. 2A through 2C, one embodiment of the application for the measurement of concentration of protein in a solution is illustrated. In practice, a layer 146 of antibodies is applied to the disk surface 140 and is configured to attract a particular type of proteins or other target objects. As can be seen, the star shaped objects are readily attracted to the antibodies, in contrast to the other shaped bodies 204, 206 and 208. In practice of certain applications, these attracted proteins are too small to appear as defects. Therefore, in referring to FIG. 2B, a secondary antibody 210 is attached to an error causing body 220 in order to cause an error. One type of obstruction is a bead, such as those used in flow cytometry. Beads and related antibodies can be attached, and often come prepackaged in many varieties. Companies such as BD Biosciences™, Miltenyi Biotec™, R&D Systems, and Dynal ™ produce such readily available beads and attached antibodies. Dynal™, for example, produces Dynabeads™ for use in flow cytometry. Such beads can be used on an optical surface to mimic defects in the optical surface that can be detected as present target entities according to the invention. Beads also exist that separate target entities from each other, from other bodies and from a solution, and are produced by Dynal™ for example. According to the invention, these products can be used in conjunction with an optically readable surface and an optical reading device to detect, measure or otherwise observe target entities within a medium, such as a liquid solution, gas, vapor or other medium.

Referring to FIG. 2C, it can be seen how these error causing entities 220 can be detected as errors in light of the beam space 118 attempting to read the pits 114 and the lands 116. In operation, a disk that is covered with such a layer 146 that attracts proteins 202 and that also attracts the error causing entities 220 will appear as errors when error checking software is operated on the disk. Thus, according to the invention, such a pre-prepared disk having antibodies on its surface can be exposed to a certain protein concentration to attract proteins 202 and can then be exposed to error causing entities having similar antibodies in order to cause errors on the disk surface. Thus, when examined using an error checking software program, these defects will show up as errors and can empirically measure the presence of the proteins that were attracted to the disk surface. In a practical application, this process can be performed on a normal disk that is capable of having or receiving such an antibody layer on its surface 140, exposed to certain proteins, rinsed off, then exposed to the secondary antibody with the error causing entity connected to it that will connect to the protein. The addition of the secondary antibodies with the error causing entities, or beads, will cause errors on the disk that can be read by error checking software. Once rinsed and dried out, the disk can simply be placed into an optical disk reader, and be read by error checking software that is configured to measure errors on the disk surface. In a practical application, after the layer is applied, an error checking procedure is performed on the disk, and the error content or percentage can be measured accordingly. Then, after exposure to the proteins and the errors causing entities with antibodies, the error percentage will naturally increase, indicating the concentration of the protein located within the medium that it was exposed in FIG. 2A.

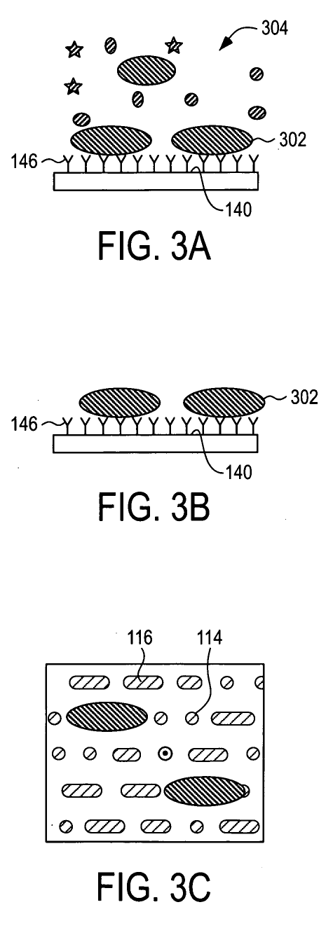

In another embodiment, the concentration of the number of cells in a solution can be measured. Since human cells are of a significant size, their presence on the disk will in and of themselves cause an error. Therefore, a disk covered with an antibody that attracts a cell, will be able to attract the cells of interest that may be located in a mixture of biological materials, and include the cells of interest. The disk may then be exposed to a solution that contains the mixture of biological materials and will pick up the cells of interest on the surface. Depending on the cells of interest, a stain may be needed in order to clearly identify the cell. The disk may then be identified using error checking software in FIG. 3C, where the cells attracted to the surface will be detected as errors when the light beam 118 is used to read the pits and lands 114, 116, respectively off of the disk.

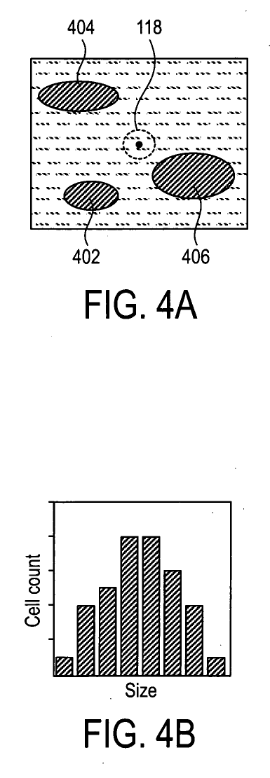

Referring to FIG. 4, the measurement of the size of the cells could be accomplished by measuring the actual cells and the area that they take up as errors on the surface of the disk that can be detected by the error checking software. The different cell sizes 402, 404, 406 can be detected according to their size by light beam 118 while the error checking software is operating on the disk surface, detecting errors and their size. Their size can be determined and graphed by size and cell count and reports can be derived such as those illustrated in FIG. 4B.

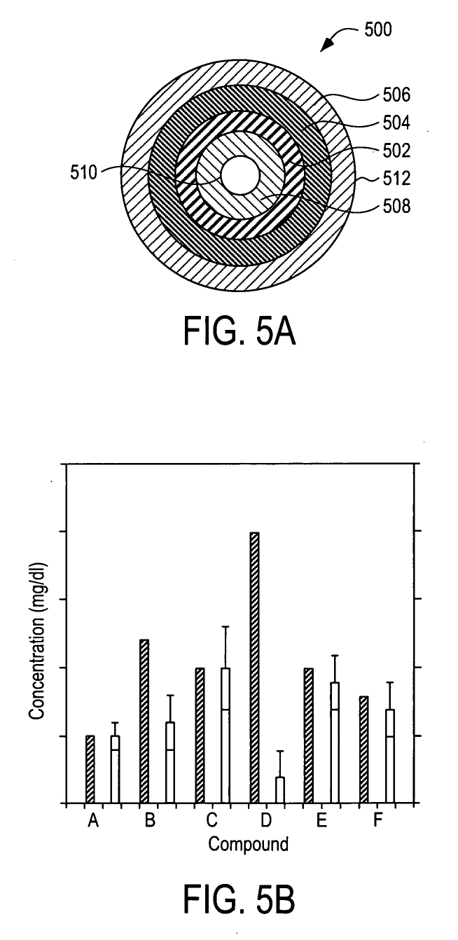

Referring to FIG. 5A, another embodiment of the invention is illustrated that shows multiplex measurements that can be performed on a single disk, where different types of antibodies can be applied to a disk that are designed to attract different types of proteins or other targets for measurement. The disk 500 is configured with several tracks 502, 504, 506 that are treated with certain antibodies for attracting particular targets. FIG. 508 may contain error checking software that is configured to determine the existence and/or measurement of the particular proteins that are attracted to the different tracks. Between the outer surface 512 and inner surface 510, any number of tracks can be added to the disk surface, and any particular type of error checking software can be imbedded on surface 508. Accordingly, the various types of targets can be tested and identified using the single disk. Referring to FIG. 5B, a report that illustrates the compound with respect to the concentration shown in a graphical form can illustrate the existence and the concentrations of the different compounds that were detected in the areas 502, 504, 506 of the disk, as well as their concentrations and other characteristics.

Those skilled in the art will understand that various types of error checking software exists and that this type of functionality can be easily implemented using conventional state of the art error checking software technology. Also, such error checking software is not limited to compact disks (CDs), but can also extend to DVDs (digital video disks) as well as HD-DVDs (high definition digital video disks), where each of these simply have a higher concentration of pits and lands and are more sensitive to defects. In fact, given the future of technology, once the pits and lands become smaller and smaller, the defects become more significant. As a result, it would be easier for the systems configured according to the invention to detect defects on a smaller scale that may not even require any secondary exposure of the error causing entities such as those illustrated in FIG. 2D and discussed above, including different sized beads connected to antibodies and other defect causing entities.

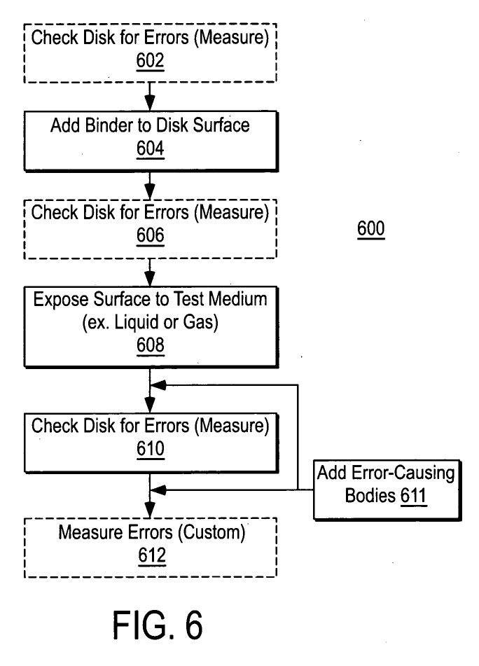

Referring to FIG. 6, one illustration of a process illustrating media proof of concept of the invention is illustrated. The process 600 begins at 602 where the disk is initially checked for errors, and possibly measured for percentage of errors that are located on the optical disk. In the next step 604, a binder is added to the disk, such as antibodies, which will reside on the surface for attraction of proteins or other targets to be measured. In step 606, an optional step, the disk is checked again for errors and measured and possibly compared to the original disk check for errors in step 602 in case there is a difference. A preferred embodiment, the antibodies cause no further errors according to the error checking software. This provides integrity for the testing of such defects so that further defects will not be caused simply by adding the binder to the disk surface. In step 608, the disk surface is exposed to the medium that is to be measured, such as a liquid or a gas. In optional step 611, an error causing body may be added to the surface in order to exacerbate the error caused by the target or protein existing in the medium in order to cause errors. In step 610, the disk is checked for errors and possibly measured for percentage of errors, indicating a concentration measurement of the target or protein. In step 612, custom measurements may be made of errors on the disk in order to provide extra information to a researcher measuring targets that are exposed to the disk.

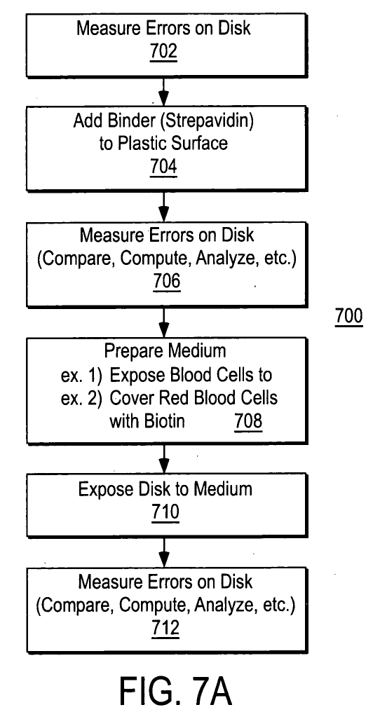

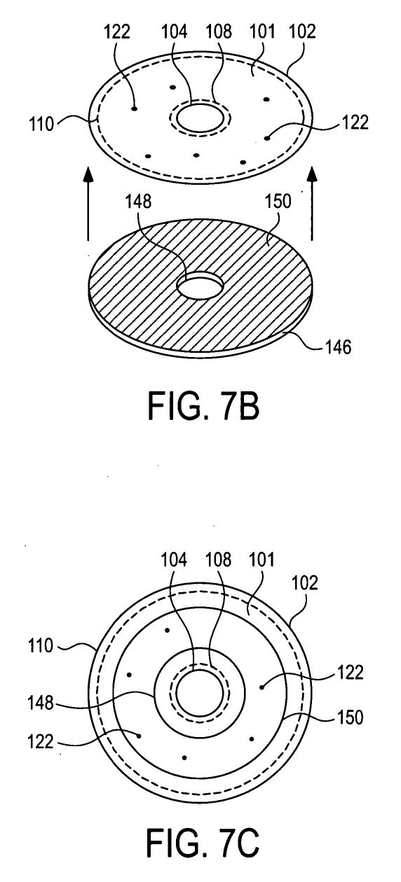

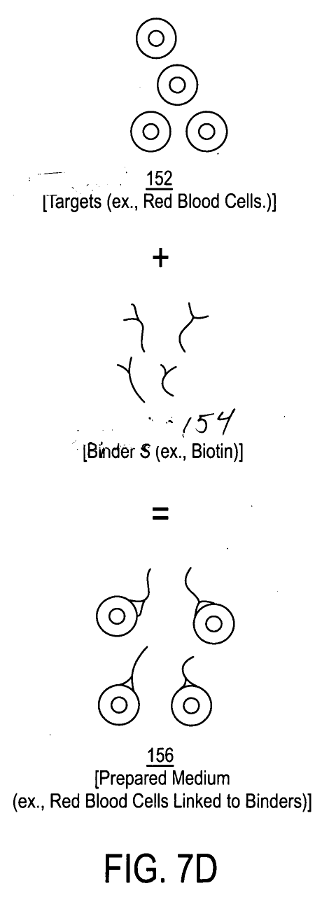

In FIG. 7A, an illustration flowchart is shown of a practical application of a disk for use in measuring targets, such as proteins which would be attracted to an antibody. In step 702, the errors are measured on a disk. In step 704, a binder such as strepavidin, to the plastic surface of the optical disk. In step 706, the errors on a disk are measured and compared, computed, and analyzed for measurement purposes. In a preferred embodiment, again, it is best that the binder added to the surface of the disk did not add any significant errors in order to add integrity to the measurement. In step 708, the medium into which the disk is to be exposed is prepared for exposure to the disk. For example, blood cells may be exposed to an antibody that is particular to the red blood cells, one example is to cover red blood cells with Biotin, which enables the blood cells to be attracted to strepavidin. In step 710, the disk is exposed to the medium, where the prepared medium, the blood cells that are covered with the attractive compound, are exposed to the disk surface that is treated with a binder. In step 710 this exposure allows the targeted blood cells to be attracted to the disk surface. In step 712, the errors on the disk are measured, which can be compared, computed, analyzed, or otherwise observed in order to determine the count of blood cells on the disk. This measurement can be done, as discussed above, using error checking software, where the red blood cells would cause errors on the disk that can be read. The red blood cells can be detected and measured using error checking software. Referring to FIG. 7B, a simplified process is illustrated where a binder is added to a disk in order to attract certain targets, such as proteins or blood cells. The disk having inner surface 104, outer surface 102 and defective reading surface is located between borders 108 and 110 includes defects 122 on surface 101. In operation, this disk would be measured and the defects would be accounted for in the error checking software. Next, a binder 146 is added to the surface in order to prepare the surface to be attractive to the targets. The surface has an inner diameter 148 and an outer diameter 150, which would coincide and not interfere with the inner diameter 104 and outer diameter 104 of the disk illustrated in FIG. 7C so that the disk can operate in a normal disk reading system. Preferably, the binder is applied between the inner readable surface 108 and outer readable surface 110 so as to not interfere with the operation of the disk in the disk reader. The binder 150 is thus ready to attract the targets, red blood cells in this example, onto the surface. Referring to FIG. 7D, the process of preparing the red blood cells is illustrated, the targets, red blood cells in this example, 152 are added to binders 152, for example, Biotin, and result in prepared blood cells 156, the prepared medium where red blood cells, in this example, are linked to the binders. Once these are exposed to the disk 102, these red blood cells that are prepared with binders are attracted to the binding surface 122. The disk can then be inserted into a conventional optical reading device, error checking software can be run in order to determine number of errors and the number of errors that correspond to the red blood cells that are attracted to the binder surface 122 can be measured, analyzed, and otherwise observed.

As a result, the invention provides a system and method for easily and inexpensively measuring the existence of targets such as proteins, enzymes, cells, or other target media into which the disk is exposed. Afterwards, these targets can be measured, analyzed, and otherwise observed for useful purposes. For example, in a third world situation where expensive equipment is not readily available, such a system according to the invention can be used simply dip a pre-prepared disk into a medium, such as a body of water, to determine whether certain pollutants, bacteria or other harmful entities exist in the water. Also, such a system could also provide an inexpensive and simple process for testing blood samples, urine samples, and other fluid samples where the existence of harmful bacteria, proteins, enzymes, certain types of cells exist. Moreover, given the ability to apply the binders to multiple tracks of the disk, several different types of targets can be measured when exposed to certain environments.

It will be apparent to those skilled in the art that the applicability of such binders to a plastic surface are readily available and widely used in other applications, and can be easily applied to an optical disk using different types of technology, for example, the spray technology used in laser printers or ink jet printers may be used to apply the binders in uniform manner on the disk, whether in a circular manner of application or a horizontal manner of application, depending on the manufacturer ability of the disks with the binder material attached. Also, many types of error inducing entities are widely available in the art. For example, BD™ CBA technology is widely used in the neonatal sepsis studies. There are also many companies that produce beads and related products pre-prepared with antibodies attached. These are used in flow cytometry discussed above. Many products exist, such as beads, that act as error causing entities. These beads are connected to detector bodies, which are connected to the lysate, serum or supernatant. Once these are mixed together, the antibodies are attracted to the beads. In flow cytometry, the beads are detected as a medium flows past a laser, and the targets are counted. According to the invention, an optically readable surface is covered with such antibodies and is exposed to a medium containing target entities. The surface can then be exposed to such beads having antibodies attached, which will attach to the target entities on the optical surface. The optical surface can then be read, perhaps using error detection software, and the presence of target entities can be detected, counted, or otherwise measured. Calculations can also be done to quantify and qualify the presence of the target entities.

Also, once antibodies are attracted to the surface of the disks, the beads having the antibodies connected thereto will be attracted to the targets that are attracted to the disk surface. This would cause the beads to be attracted to the disk, flagging or otherwise indicating that the targets, such as the enzyme, protein, blood cell, or other target entity has been attracted to the binder on the surface of the optical disk. Finally, the disk can be rinsed, dried out, and analyzed in a typical optical reading system, where the bound targets along with their error causing entities, such as beads, can be read as errors in the optical disk.

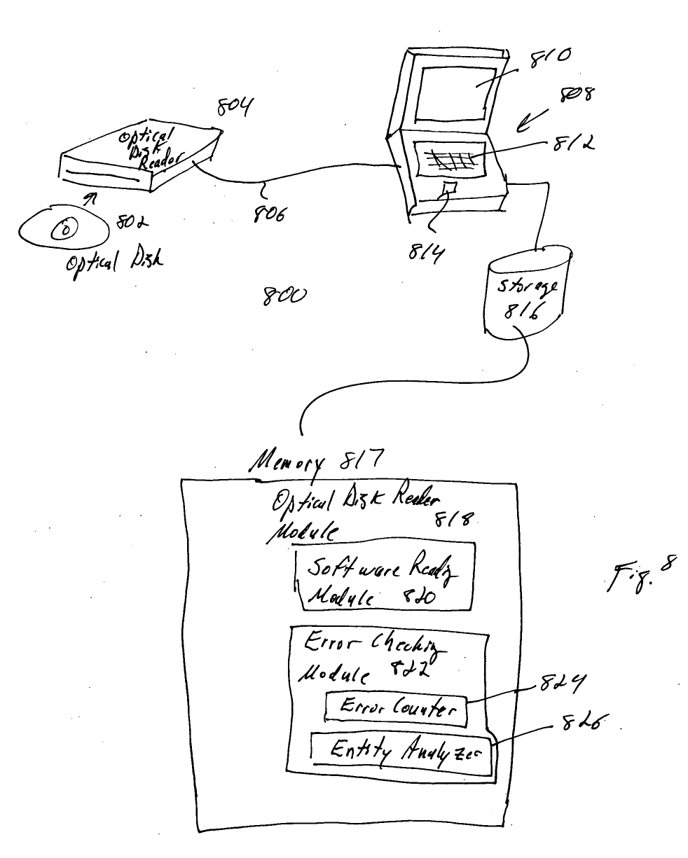

Referring to FIG. 8, one embodiment of the invention is illustrated as a system 800 for reading an optical disk 802 according to the invention. The optical disk 802 is inserted into the optical disk reader 804, where it may be read using conventional optical reading means, not shown. The optical reader may be a conventional optical reading device that is typically available as a separate component connected via a communication cable 806 to a computer 808, which may be a laptop or a desktop computer, or it may be built in to a computer. It may also be a separate dedicated optical reader that is configured according to the invention to operate separately. The computer, such as the laptop 808 shown, may include a built on screen 810, input keyboard 812 and mouse pad 814. The computer may be connected to a separate storage unit 816, or may have built in storage for operation of the invention. In the storage unit a memory module 817 may include an optical disk reader module 818 having software that, when processed by the computer 808, causes the optical reader functions to occur according to the invention. The reader module includes a software reading module 820 that is configured to read software code that may be stored on the optical disk 802. Such software may include general optical reading code that is typically included in a consumer computer, or may have dedicated software for use in performing functions according to the invention discussed above. The memory may include error checking module 822 configured to check errors on the optical disk as discussed above. The module 822 may include an error counter 824 configured to count errors occurring on the disk 802, which may be used to check errors occurring on the disk before exposure to target entities, as well as checking for errors after being exposed to a medium of target entities. It may also be used to check for errors after the target entities are bound to a disk and subsequently exposed to obstructions that are bound to the target entities, such as beads, also discussed above. The entity analyzer 826 is also stored in memory, and is configured to analyze the target entities that are detected on the optical disk. The software in the analyzer may be error checking software configured to count the number of target entities detected by the optical reader. It may further be analysis software configured to analyze other aspects of the target entities such as concentration, size and other characteristics. Those skilled in the art will understand that there exist many types of error checking software modules with code for checking and analyzing errors on an optical disk. The invention, however, is not limited to any particular module.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. An optically readable device for use in an assay process comprising:
a surface readable by an optical reading device; and
at least one binder located on the surface for exposure to a medium and configured to bind to a target entity that may be present in the medium.

2. An optically readable disk according to claim 1, wherein the binder is embedded in the plastic surface.

3. An optically readable disk according to claim 1, wherein the binder is an active amino group embedded in the plastic surface.

4. An optically readable device according to claim 1, further comprising an identifier configured to bind to a target entity to aid in detecting the presence of any target entities on the surface.

5. An optically readable device according to claim 1, where in the surface includes a top layer configured to hold at least one binder, and an inner layer configured to retain optically readable inner surface entities, the device further comprising software code that, when processed by a data processor, enables the data processor to detect the presence of any target entities on the top layer.

6. An optically readable device according to claim 4, where in the surface includes a top layer configured to hold at least one binder and an inner layer configured to retain optically readable inner surface entities, the device further comprising software code that, when processed by a data processor, enables the data processor to detect the presence of any identifiers on the top layer.

7. An optically readable device according to claim 1, further comprising an optically readable disk and optically readable code located on a section of the optical disk, where the code, when read and processed by a data processor, enables the data processor to detect the presence of any target entities on the surface.

8. An optically readable device according to claim 1, where in the surface includes a top layer configured to hold at least one binding entity, and an inner layer configured to retain optically readable surface entities located on the inner layer.

9. An optically readable device according to claim 1, where in the surface includes a top layer configured to hold at least one binding entity, and an inner layer configured to retain optically readable inner surface entities, the device further comprising software code that, when processed by a data processor, enables the data processor to detect the presence of any target entities on the top layer.

10. An optically readable device according to claim 1, where in the surface includes a top layer configured to hold at least one binding entity, and an inner layer configured to retain optically readable inner surface entities, the device further comprising optically readable code located on a section of the inner layer in the form of optically readable entities, where the code, when read by an optical reading device and processed by a data processor, enables the data processor to detect the presence of any target entities on the top layer.

11. An optically readable disk according to claim 1, where in the surface includes a top layer configured to hold at least one binding group and an inner layer configured to retain optically readable target entities, the optical disk further comprising optically readable code located on a section of the inner layer in the form of optically readable entities, where the code, when read by an optical reading device and processed by a data processor, enables the data processor to detect the presence of any target entities bound to a binding group on the top layer.

12. An optically readable disk according to claim 11, wherein the top layer further includes active amino groups embedded therein configured to bind to target entities located within the medium.

13. An optically readable disk according to claim 5, wherein the optically readable code includes code configured to enable an optical reading device to detect errors at positions on the top layer where target entities in the medium bind to the binding entity.

14. An optically readable disk according to claim 5, wherein the optically readable code includes code configured to enable an optical reading device to detect errors at positions on the top layer where target entities in the medium bind to the binding entity, wherein a processor, when executing the code, is configurable to determine whether a number of read errors is related to the number of target entities located in the medium.

15. A method of measuring the concentration of a material in a solution, the method comprising:
treating an optical disk with a binding entity to a material of interest;
exposing the disk to a solution containing the material of interest, such that the material of interest binds to the binding entity;
reading the disk in an optical disk reader; and
counting the number of read errors caused by the material of interest on the optical disk;
wherein the number of read errors is proportional to an amount of the material of interest.

16. The method of claim 15, wherein prior to reading the disk, the disk is exposed to a secondary binding entity to the material of interest, wherein the secondary binding entity carries a substance which will cause a read error.

17. The method of claim 15, wherein different disk sections are treated with different binding entities.

18. A method of measuring the size of a target entity, the method comprising:
treating an optical disk with an antibody to the target entity;
exposing the disk to a solution containing the target entities, such that the target entities bind to the antibody;
reading the optical disk in an optical disk reader; and
analyzing read errors from the optical disk reader caused by the target entities, such that error analysis determines a pattern of the errors and a corresponding size of the target entities.

19. A method according to claim 18, wherein the target entity is a cell.

20. A method according to claim 18, wherein the optical disk is treated with a plurality of antibodies configured to bind different target entities.
